(19) United States
(12) Patent Application Publication
(10) Pub. No.: US 2009/0177581 A1
(43) Pub. Date: Jul. 9, 2009

(54) METHOD OF CASH-LESS, CARDLESS PURCHASE TRANSACTION USING MOBILE PHONES

(75) Inventors: Rodell Garcia, Mandaluyong City (PH); Raul Macatangay, Mandaluyong City (PH); Mickey Cayetano, Mandaluyong City (PH); Grace Reyes, Mandaluyong City (PH); Jewel Dimaano, Mandaluyong City (PH); Marlowe Pongol, Mandaluyong City (PH); Sheila Jimenez, Mandaluyong City (PH); Melenita Quito, Mandaluyong City (PH); Jenny Villanueva, Mandaluyong City (PH); Justine Camacho, Mandaluyong City (PH); Glenn Mendoza, Mandaluyong City (PH); Kaytee Reyes, Mandaluyong City (PH); Shydee Buizon-Tiambeng, Mandaluyong City (PH); Jessica A. Reyes, Mandaluyong City (PH); Joanne Avendano, Mandaluyong City (PH); Verna Quinton, Mandaluyong City (PH); Alain Bustamante, Mandaluyong City (PH); Louie Domingo, Mandaluyong City (PH); Fernando P. Teodoro, Mandaluyong City (PH); Richard Matotek, Mandaluyong City (PH); Andrew Barnham, Balcarat (AU); Justin Ho, Labu Asap (SG)

Correspondence Address: EDWARDS ANGELL PALMER & DODGE LLP, P.O. BOX 55874, BOSTON, MA, 02205, US

(73) Assignees: G-XCHANGE, INC.; UTIBA PTY LTD.

(21) Appl. No.: 12/069,509

(22) Filed: Feb. 11, 2008

Related U.S. Application Data
(63) Continuation of application No. PCT/PH2006/000007, filed on May 23, 2006.

(30) Foreign Application Priority Data
Aug. 22, 2005 (PH) 1-2005-000420

(51) Int. Cl. G06Q 20/00

(52) U.S. Cl. 705/44

(57) ABSTRACT

The method of cash-less purchase transaction using mobile phone comprising steps of: —customer requesting for purchase at outlet; —merchants verifying if customer is registered with telco's cash product service; —merchant informing the customer of the purchase price to e paid; —merchant sending in a SELL command on his device to a telco containing merchant's PIN, amount of the purchase, and customer's mobile phone number; —customer receiving SMS confirmation query of the amount to be paid from telco; —customer's mobile phone number; —customer replying to the SMS of his confirmation with his PIN; —merchant receiving confirmation from telco of the deduction from customer's mobile phone cash account; —merchant releasing product to the customer; —customer receiving confirmation of the deduction via SMSD sent to his mobile phone; —alternatively, merchant using mobile phone device informing customer of the merchant's mobile number which the customer can send his virtual cash to; —customer sending the amount via SMS to 2882+the 10 digit mobile number of the merchant; —the subscriber and the merchant then getting simultaneous SMS acknowledgment of the transfer with confirmation number

### RELATED APPLICATIONS

This is a continuation patent application that claims priority to PCT patent application number PCT/PH2006/000007, filed on May 23, 2006, which claims the benefit of Philippines application no. 1-2005-000420, filed on Aug. 22, 2005, the entirety of which are herein incorporated by reference.

### FIELD OF INVENTION

This invention relates in general t mobile phones but ore particularly to a method of cash-less, card-less purchase transactions using mobile phones.

Heretofore, cash-less transaction involved credit cards wherein after choosing products to be purchased, the credit cards are physically swiped on a point of sale (POS) machine as in groceries and department stores. Others used credit card information when doing home T.V. shopping or internet shopping.

The mobile phones are also used to execute quasi-financial transactions, such as purchasing airtime load, passing load credits, inquiring bark balance, transferring funds from one bank account to another account, paying bills.

However, replacing credit card usage with the use of mobile phones is not yet conceived.

It is the primary object of the present invention to provide a cash-less, card-less purchase transaction using mobile phone that eliminate the use of credit cards or credit card companies, that is, one has to convert cash into virtual cash and load it to his mobile phone cash account using a telephone company's (telco) cash product services as depositing in a bank.

Another object is to provide a transaction method wherein the mobile phone is transformed into a point o sale machine which virtually any product could be bought. The telco's outlet or 3^{rd} party (merchant) can initiate the purchase transaction through a range of devices including mobile phone, web portal, point-of-sale terminal.

Still an object is to provide a transaction method wherein authorization and billing could be executed using Short Messaging Service (SMS) and would only consume a few seconds much faster than credit card transaction.

These and other objects and advantage of the present invention will become apparent upon reading the following detailed description taken in conjunction with the appended drawings, wherein:

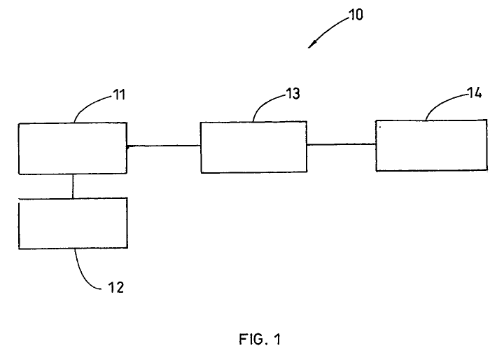

FIG. 1 is a block diagram of the components of the invention; and

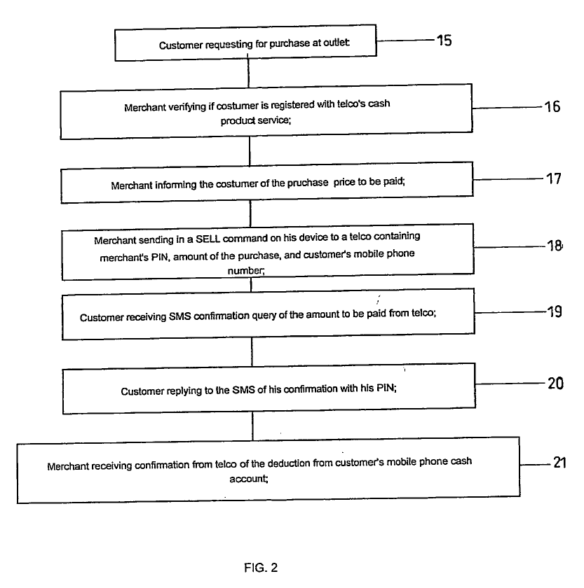

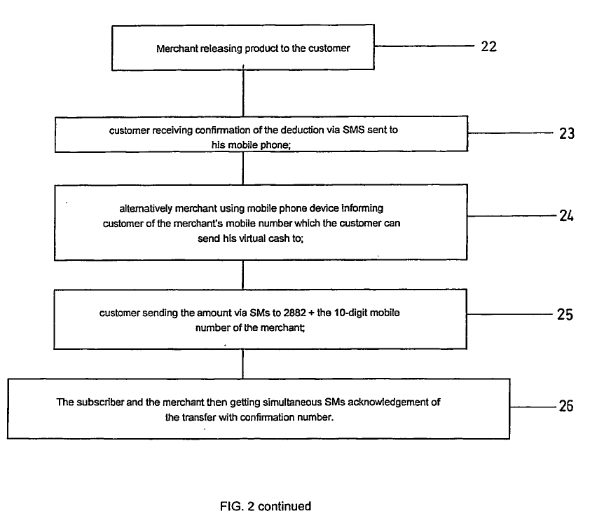

FIG. 2 is a flow diagram of the transaction method.

Referring now to the several views of the drawings wherein like reference numerals designate the same parts throughout, there is shown my invention for a method of cash-less, card-less purchase transaction using mobile phones generally designated as 10.

The components involved in the invention are a customer 11, his mobile phone cash account 12, a merchant 13 and a teleco 14 which are all united by software.

Upon choosing a product from a merchant, the customer requests (15) for purchase at the merchant's outlet.

The merchant verifies (16) if customer is registered to the telco's cash product service. If verified, the merchant informs (17) the customer of the purchase price to be paid.

The merchant sends in (18) a SELL command message to the telco containing customer's mobile phone number and the purchase price.

The telco verifies (18a) that the customer's mobile phone is registered with the telco's 14 cash product services and that the purchase amount is available in the customer's mobile phone cash account. The customer's mobile phone cash account maybe from the telco's cash product service where cash is converted to virtual cash and loaded to the customer's mobile phone cash account, or from customer's bank account or credited to customer's credit card account.

The telco sends (19) a confirmation query to the customer of the purchase price.

Then, the customer sends (20) a confirmatory reply to the telco.

The telco deducts the customer's mobile phone cash account/customer's bank account or credits to customer's credit card account the purchase amount and credits the same amount to the merchant (20a).

The merchant then receives (21) an acknowledgment with confirmation number from telco in a format that corresponds to the device.

The merchant releases (22) the product to the customer.

Customer receives (23) SMS acknowledgment and confirmation number from telco.

Alternatively, merchant using mobile phone device, informs (24) the customer of the merchant's mobile number which the customer can send his virtual cash to.

Customer sends (25) the amount via SMS to 2882+the 10-digit mobile number of the merchant.

The telco deducts the customer's mobile phone cash account with the purchase price and credits the same amount to the merchant (20a).

The subscriber and the merchant then get (26) simultaneous SMS acknowledgment of the transfer and confirmation number from telco.

I claim:

1. The method of cash-less purchase transaction using mobile phone comprising the steps of:
customer requesting for purchase at outlet;
merchant verifying if customer is registered with teleco cash product service;
merchant informing the customer of the purchase price to be paid;
merchant sending in a SELL command on his device to a telco containing merchant's PIN, amount of the purchase, and customer's mobile phone number;
customer receiving SMS confirmation query of the amount to be paid from telco;
customer replying to the SMS of his confirmation with his PIN;
merchant receiving confirmation from telco of the deduction from customer's mobile phone cash account;
merchant releasing product to the customer;
customer receiving confirmation of the deduction via SMS sent to his mobile phone;
alternatively, merchant using mobile phone device informing customer of the merchant's mobile number which the customer can send his virtual cash to;
customer sending the amount via SMs to 2882+the 10-digit mobile number of the merchant;
the subscriber and the merchant then getting simultaneous SMS acknowledgment of the transfer with confirmation number.
